(19) United States
(12) Patent Application Publication
(10) Pub. No.: US 2016/0261166 A1
(43) Pub. Date: Sep. 8, 2016

(54) ACTUATOR ASSEMBLY WITH A MAGNETIC COUPLING

(71) Applicant: American Axle & Manufacturing, Inc., Detroit, MI (US)

(72) Inventors: Peyman Moradshahi, Rochester Hills, MI (US); Frederick E. Zink, Capac, MI (US)

(21) Appl. No.: 15/051,716

(22) Filed: Feb. 24, 2016

Related U.S. Application Data
(60) Provisional application No. 62/128,007, filed on Mar. 4, 2015.

(51) Int. Cl. H02K 7/06; H02K 49/10; H02K 5/04

(52) U.S. Cl. CPC H02K 7/06; H02K 5/04; H02K 49/104

(57) ABSTRACT

An actuator that includes a housing, first and second drive portions, a rotary-to-linear converter and an output member. The housing defines a first housing part and a second housing part that is segregated from first housing part by a housing wall. The first drive portion is housed in the first housing part and has a source of rotary power and an intermediate output that is driven by the source of rotary power. The second drive portion is housed in the second housing part and has an intermediate input and a transmission. The intermediate input receives rotary power from the intermediate output and transmits rotary power to the transmission. The intermediate input does not physically contact the intermediate output and the housing wall is disposed between the intermediate output and the intermediate input. The rotary-to-linear converter driven by the transmission. The output member translated along an axis by the rotary-to-linear converter.

### CROSS-REFERENCE TO RELATED APPLICATIONS

This application claims the benefit of U.S. Provisional Application No. 62/128,007 filed Mar. 4, 2015, the disclosure of which is incorporated by reference as if fully set forth in detail herein.

### FIELD

The present disclosure relates to an actuator assembly with a magnetic coupling.

### BACKGROUND

This section provides background information related to the present disclosure which is not necessarily prior art.

Actuator assemblies for moving an axially shifting element of a device, particularly actuator assemblies that are employed to translate an element in a driveline component, commonly have electronic components that are preferably sealed from lubricants that are employed to lubricate the device. In some situations, it is possible to house the electronic components in a housing and to employ a seal to segregate the electronic components from a portion of the actuator assembly that is exposed to the lubricant. In certain situations, however, we have noted that a seal does not provide an adequate solution as the seal can become very complicated, rendering it costly to manufacture and install. Accordingly, an improved actuator assembly is needed in which certain electronic components of the actuator assembly are better segregated from the portion of the actuator assembly that is exposed to lubricant.

### SUMMARY

This section provides a general summary of the disclosure, and is not a comprehensive disclosure of its full scope or all of its features.

In one form, the present teachings provide an actuator that includes a housing, first and second drive portions, a rotary-to-linear converter and an output member. The housing defines a first housing part and a second housing part that is segregated from first housing part by a housing wall. The first drive portion is housed in the first housing part and has a source of rotary power and an intermediate output that is driven by the source of rotary power. The second drive portion is housed in the second housing part and has an intermediate input and a transmission. The intermediate input receives rotary power from the intermediate output and transmits rotary power to the transmission. The intermediate input does not physically contact the intermediate output and the housing wall is disposed between the intermediate output and the intermediate input. The rotary-to-linear converter driven by the transmission. The output member translated along an axis by the rotary-to-linear converter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a section view of an exemplary actuator assembly constructed in accordance with the teachings of the present disclosure;

FIG. 2 is an enlarged portion of FIG. 1 illustrating a magnetic coupling that is employed to transmit rotary power between a first drive portion and a second drive portion'

FIG. 3 is a perspective view of a portion of the magnetic coupling;

FIG. 4 is an exploded perspective view of an alternately constructed magnetic coupling;

FIG. 5 is a side elevation view in partial section illustrating a second part of the magnetic coupling and a transmission; and

FIG. 6 is a side elevation view of an alternately constructed magnetic coupling.

Corresponding reference numerals indicate corresponding parts throughout the several views of the drawings.

### DETAILED DESCRIPTION

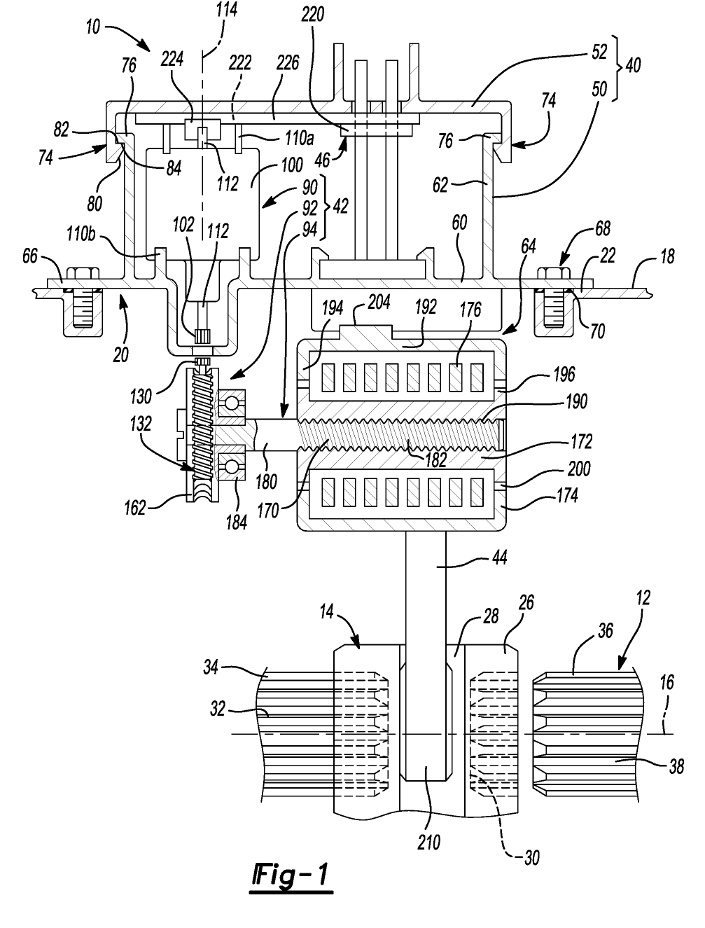

With reference to FIG. 1 of the drawings, an exemplary actuator assembly 10 constructed in accordance with the teachings of the present disclosure is shown in operative association with a driveline component 12. The driveline component 12 can be any type of device that is configured to transmit rotary power and can include an axially movable element 14 that can be moved along a shift axis 16 between two or more positions to change the operation of the driveline component 12 in a predetermined manner. For example, movement of the axially movable element 14 by the actuator assembly 10 could selectively interrupt the transmission of rotary power through the driveline component 12 and/or could selectively change an overall speed ratio (e.g., reduction ratio) of the driveline component 12. Exemplary driveline components having an axially movable element are disclosed in commonly owned U.S. Pat. Nos. 8,042,642 and 8,795,126, the disclosure of which are hereby incorporated as if fully set forth in detail herein.

A detailed discussion of the driveline component 12 is beyond the scope of this disclosure. Briefly, the driveline component 12 can include a housing 18 into which the axially movable element 14 is received. The housing 18 can define an actuator aperture 20, which permits access to the axially movable element 14 by actuator assembly 10, and a mounting flange 22 that can be disposed about the perimeter of the actuator aperture 20. In the particular example provided, the axially movable element 14 has an annular body 26, an annular groove 28, which is formed into the exterior outer perimeter of the annular body 26, and a plurality of internal teeth 30 that are formed into the interior perimeter of the annular body 26. The internal teeth 30 can extend longitudinally in a direction that is parallel to the shift axis 16. The internal teeth 30 can be non-rotatably but axially slidably mounted to external teeth 32 formed on a first shaft 34 and can be moved along the shift axis 16 into engagement with external teeth 36 formed on a second shaft 38 to thereby couple the first and second shafts 34 and 38 for common rotation about the shift axis 16.

The actuator assembly 10 can include an actuator housing assembly 40, a drive assembly 42, an output member 44 and a controller 46. The actuator housing assembly 40 can include a mounting base 50 and a cover 52.

The mounting base 50 can be formed of an appropriate material, such as a structural plastic or a metal, such as aluminum or magnesium. The mounting base 50 can have a housing wall 60 that can define a first housing portion 62, a second housing portion 64 and a flange 66. The first housing portion 62 can be disposed on a first side of the housing wall 60 and can include various mounts for portions of the drive assembly 42 and the controller 46 as will be described in more detail below. The second housing portion 64 can be disposed on a second side of the housing wall 60 opposite the first housing portion 62 and can include various mounts for portions of the drive assembly 42 as will be described in more detail below. The housing wall 60 can be a non-porous structure that can segregate the components of the actuator assembly 10 residing in the first housing portion 62 from lubricants, etc. to which the components of the actuator assembly residing in the second housing portion 64 are exposed. The flange 66 can extend about the second housing portion 64 and can be configured to be coupled to the mounting flange 22 (e.g., via a plurality of mounting bolts 68 that extend through the flange 66 and threadably engage the mounting flange 22) to permit the mounting base 50 to close or cover the actuator aperture 20. In the example provided, a gasket 70 is disposed between the flange 66 and the mounting flange 22, but it will be appreciated that the joint between the mounting base 50 and the housing 18 could be constructed differently.

The cover 52 can be formed of an appropriate metal or plastic material and is configured to engage the mounting base 50 to cover the first housing portion 62 to prevent the ingress of dirt and/or moisture therein. In the particular example provided, the cover 52 is formed of a resilient plastic material and includes a plurality of anchoring barbs 74 that are engaged to anchoring lugs 76 formed on the first housing portion 62. In the example provided, each of the anchoring barbs 74 is cantilevered from a remaining portion of the cover 52 and defines a ramp surface 80 and an abutment surface 82. The ramp surface 80 can be configured to contact an outwardly extending rim 84 of a corresponding one of the anchoring lugs 76 and can be tapered so as to cause the anchoring barb 74 to deflect outwardly (away from the anchoring lug 76) as the cover 52 is urged toward the mounting base 50. The anchoring barb 74 is configured to spring back toward the anchoring lug 76 once the cover 52 has been positioned in a seated position proximate the mounting base 50 and the ramp surface 80 as disengaged the outwardly extending rim 84 of the anchoring lug 76. The springing back of the anchoring barb 74 can position the abutment surface 82 in-line and optionally in engagement with the outwardly extending rim 84 of the anchoring lug 76 to inhibit the withdrawal of the cover 52 from the mounting base 50.

The drive assembly 42 can include a first drive portion 90, a second drive portion 92 and a rotary-to-linear converter 94.

The first drive portion 90 can comprise a source of rotary power, such as an electric motor 100 and an intermediate output 102. Optionally, the first drive portion 90 can include a transmission (not shown) between the electric motor 100 and the intermediate output 102 that can provide a desired gear (reduction (gear) ratio between the electric motor 100 and the intermediate output 102. The electric motor 100 can be mounted on a pair of motor mounts 110a, 110b that can be formed on the first housing portion 62. The motor mounts 110a, 110b can orient the electric motor 100 such that an output shaft 112 of the electric motor 100 is rotatable about a rotational axis 114.

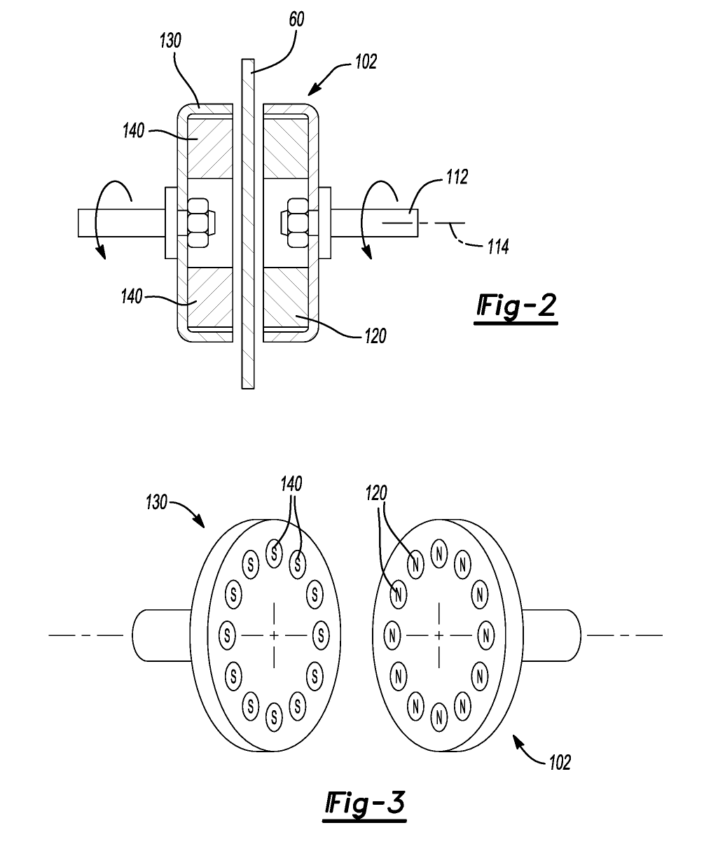

With reference to FIGS. 2 and 3, the intermediate output 102 can be a first part of a magnetic coupling and can comprise one or more magnets 120 that can be disposed about a rotational axis of the intermediate output 102. In the particular example provided, the intermediate output 102 is directly driven by the output shaft 112 of the electric motor 100 and as such, the intermediate output 102 is rotatable about the rotational axis 114 of the output shaft 112. The magnets 120 of the intermediate output 102 can be disposed in a desired order, such as parallel to the rotational axis 114 of the output shaft 112, and in a manner in which their magnetic poles are staggered. For example, each of the magnets 120 can be disposed such that its north pole (N) is disposed proximate the housing wall 60.

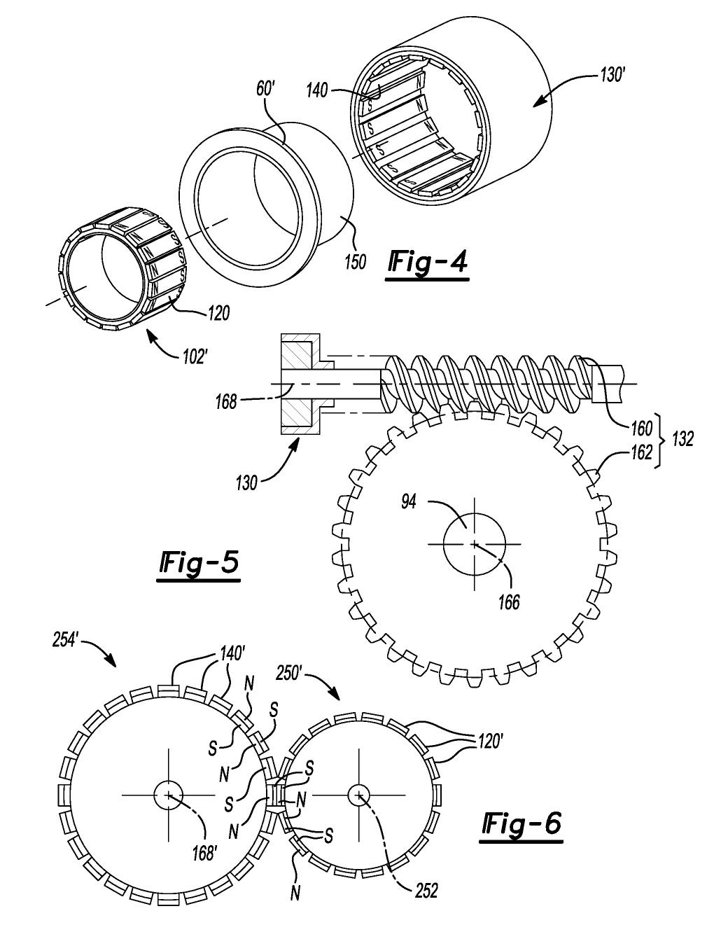

Returning to FIG. 1, the second drive portion 92 can comprise an intermediate input 130 and a transmission 132. With reference to FIGS. 2 and 3, the intermediate input 130 can be a second part of a magnetic coupling and can be configured to magnetically couple to the intermediate output 102 (i.e., through the housing wall 60) so as to be capable of transmitting rotary power there between. In the example provided, the intermediate input 130 can comprise a plurality of magnets 140 that can be disposed about a rotational axis of the intermediate input 130, which can be coincident with the rotational axis of the intermediate output 102. The magnets 140 of the intermediate input 130 can be disposed in a desired order, such as parallel to the rotational axis of the intermediate input 130, and in a manner in which their magnetic poles are complementary to the ordering of the magnetic poles of the intermediate input 102. For example, each of the magnets 140 can be disposed such that its south pole (S) is disposed proximate the housing wall 60. In the particular example provided, the magnets 120 and 140 of the intermediate output 102 and intermediate input 130 are spaced apart along the rotational axis 114 of the output shaft 112. It will be appreciated, however, that the magnets 120 and 140 could be positioned somewhat differently. For example, the magnets 120 and 140 could be made to overlap in an axial direction as shown in FIG. 4. In this example, the housing wall 60′ is formed with a cup-shaped section 150 into which the intermediate output 102′ is received and the intermediate input 130′ is formed as an annular manner that is disposed about the cup-shaped section 150. Construction in this manner permits the magnets 120 and 140 to overlap one another in an axial direction along their rotational axes.

With reference to FIG. 5, the intermediate input 130 can transmit rotary power to the transmission 132, which can output rotary power to the rotary-to-linear converter 94. In the example provided, the transmission 132 includes a worm 160 and a worm wheel 162, which can be the output of the transmission 132. The worm 160 can be fixedly coupled to the intermediate input 130 so as to rotate about a common rotational axis. The worm wheel 162 can be meshingly engaged to the worm 160 and can be configured to rotate about an axis 166 that is transverse to the rotational axis 168 of the worm 160. Various mounts (not specifically shown) can be formed into the mounting base 50 that can maintain the worm 160 and the intermediate input 130 in a desired orientation such that their rotational axes are coincident with the rotational axis of the intermediate output 102 and the intermediate input 130 is spaced relative to the housing wall 60 by a desired amount.

Returning to FIG. 1, the rotary-to-linear converter 94 is configured to convert the rotary motion that is input from the output of the transmission 132 (i.e., the worm wheel 162 in the example provided) to a linear motion that is configured to translate the output member 44. In the example provided, the rotary-to-linear converter 94 comprises a jackscrew 170, a bobbin 172, a cradle 174 and a biasing spring 176. The configuration of the rotary-to-linear converter 94 can be generally similar to that which is described in commonly assigned co-pending U.S. patent application Ser. No. 14/460,661 entitled “Power Transmitting Component With Twin-Fork Actuator”, the disclosure of which is incorporated by reference as if fully set forth in detail herein. Briefly, the jackscrew 170 can include a shaft portion 180, which can be coupled to the worm wheel 162 for common rotation, and a threaded section 182 that can be coupled to the shaft portion 180 for common rotation. A bearing 184 can be coupled to the mounting base 50 and can be employed to support the jackscrew 170 for rotation. The bobbin 172 can be formed in two or more pieces and can define a central threaded aperture 190, a central body 192 and a pair of end flanges 194 and 196. The threaded section 182 of the jackscrew 170 can be threadably engaged to the central threaded aperture 190. The cradle 174 can define a frame-like structure having an open center with a bobbin aperture 200 formed there through that is sized to receive the bobbin 172. The cradle 174 can be mounted to the mounting base 50 for movement that is parallel to the shift axis 16. In the particular example provided, the cradle 174 is mounted to a discrete guide bar 204 that is integrally formed with a remainder of the mounting base 50. It will be appreciated, however, that the guide bar 204 could be a discrete structure that can be assembled to the remainder of the mounting base 50. The biasing spring 176 can be received on the central body 192 of the bobbin 172 and can abut the end flanges 194 and 196. The end flanges 194 and 196 can be sized such that only a portion of each end of the biasing spring 176. In the example provided, each of the end flanges 194 and 196 is sized to create two discrete zones of contact with a corresponding end of the biasing spring 176. Each of the zones can be disposed 180 degrees from one another. Each end of the biasing spring 176 can additionally contact a portion of the cradle 174 proximate the bobbin aperture 200. When the cradle 174 is able to translate freely parallel to the shift axis 16, the biasing spring 176 will maintain the cradle 174 in alignment with the bobbin 172 (i.e., the bobbin 172 will be centered in the cradle 174). The positioning of the biasing spring 176 between end flanges 194 and 196 and the cradle 174 in this manner permits the bobbin 172 to translate parallel to the shift axis 16 by a limited amount dictated by the biasing spring 176 in situations where the cradle 174 is not able to move with the bobbin 172. In situations where the bobbin 172 has moved relative to the cradle 174, the biasing spring 176 can provide a biasing force that is exerted onto the cradle 174 to cause the cradle 174 to move back into alignment with the bobbin 172.

The output member 44 can be configured to transfer motion of the cradle 174 to motion of the axially movable element 14. In the particular example provided, the output member 44 comprises a shift fork having a pair of arms 210 (only one shown) that are received into the annular groove 28 formed about the axially movable element 14. The output member 44 can be coupled to the cradle 174 in any desired manner. Moreover, the output member 44 could be integrally formed with the cradle 174 in instances where the output member 44 is fixedly coupled to the cradle 174.

The controller 46 can include a control unit 220 and a plurality of sensors. The sensors can comprise a rotary position sensor 222 that can be configured to sense a rotational position of a rotary sensor target 224 and to responsively generate a position signal. The rotational position of the rotary sensor target 224 can be associated with a rotational position of the intermediate output 102 in a desired manner. For example, the rotary sensor target 224 can be coupled to the output shaft 112 or to the intermediate output 102 for common rotation. Alternatively, the rotary sensor target 224 could be driven through a reduction drive (not shown) that can be driven by the output shaft 112 or the intermediate output 102. In the particular example provided, the rotary position sensor 222 is a Hall-effect sensor, which is mounted to a printed circuit board 226, and the rotary sensor target 224 is coupled to an end of the output shaft 112 opposite the intermediate output 102. The printed circuit board 226 can be fixedly coupled to the cover 52. The control unit 220 can be coupled to the printed circuit board 226 and can be configured to control the operation of the electric motor 100 to drive the cradle 174 to a desired position. The control unit 220 can be coupled to the rotary position sensor-and can receive the rotary position signal therefrom. The control unit 220 can also be coupled to a source of electrical power (not shown) and optionally to an in-vehicle network (not shown), such as a CAN bus, and can communicate in a desired manner with other vehicle systems. The controller 46 can optionally include other sensors, such as a temperature sensor (not shown) and/or a linear position sensor (not shown). The temperature sensor can sense a temperature of a portion of the actuator assembly 10, such as the electric motor 100, or a temperature of a portion of the driveline component 12, and can responsively generate a temperature signal. The linear position sensor can sense a position of an element of the actuator assembly 10, such as the cradle 174 or the output member 44, along a desired axis and can responsively generate a linear position signal.

While the actuator assembly 10 has been described as having a drive assembly 42 that employs a magnetic coupling having parts that are disposed about a common rotational axis, those of skill in the art will appreciate that the invention, in its broader aspects, could be configured somewhat differently. In this regard, the first and second parts of the magnetic coupling could be configured to rotate about axes that are parallel to one another as is depicted in FIG. 6. In this example, the first part 250′ of the magnetic coupling has magnets 120′ that extend radially outwardly from a rotational axis 252 of the first part 250′. The magnets 120′ can be circumferentially spaced apart about the rotational axis 252 and can have poles that can be staggered in a desired manner (e.g., alternated). The second part 254′ of the magnetic coupling can be configured in a similar manner (i.e., with magnets 140′ that extend radially outwardly from a rotational axis 168′ of the second part 254′ and which are circumferentially spaced apart about the rotational axis 168′ with their poles staggered in a manner that is complementary to the staggering of the poles of the first part 250′). Rotary power can be transmitted between the first and second parts 250′ and 254′ in a manner that is similar to spur gearing in that the poles of the magnets 120′ on the first part 250′ can cause cogged motion of the second part 254′.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An actuator comprising:
a housing defining a first housing part and a second housing part that is segregated from first housing part by a housing wall;
a first drive portion having an electric motor and an intermediate output that is driven by the electric motor, the first drive portion being housed in the first housing part;
a second drive portion having an intermediate input and a transmission, the second drive portion being housed in the second housing part, the intermediate input receiving rotary power from the intermediate output and transmitting rotary power to the transmission, wherein the intermediate input does not physically contact the intermediate output and wherein the housing wall is disposed between the intermediate output and the intermediate input;
a rotary-to-linear converter driven by the transmission; and
an output member translated along an axis by the rotary-to-linear converter.

2. The actuator of claim 1, wherein the intermediate output and the intermediate input are disposed about a common rotational axis.

3. The actuator of claim 2, wherein the intermediate output and the intermediate input are disposed coaxially.

4. The actuator of claim 2, wherein the intermediate output and the intermediate input are spaced apart along the common rotational axis.

5. The actuator of claim 1, wherein the intermediate output is rotatable about a first axis and the intermediate input is rotatable about a second axis that is not coincident with the first axis.

6. The actuator of claim 5, wherein the second axis is parallel to the first axis.

7. The actuator of claim 1, wherein the intermediate output comprises a plurality of first magnets and the intermediate input comprises a plurality of second magnets that cooperate with the first magnets to transmit rotary power between the intermediate output and the intermediate input.

8. The actuator of claim 7, wherein each of the first magnets produces a first magnetic field, wherein each of the second magnets produces a second magnetic field and wherein the first magnetic fields magnetically cog with the second magnetic fields to transmit rotary power between the intermediate output and the intermediate input.

9. The actuator of claim 7, wherein the first magnets cooperate with the second magnets to resist relative rotation between the intermediate output and the intermediate input.

10. The actuator of claim 1, wherein the rotary-to-linear converter comprises a jackscrew and a bobbin that is threaded to the jackscrew.

11. The actuator of claim 10, wherein the rotary-to-linear actuator further comprises a spring and a cradle, the spring being disposed between the bobbin and the cradle, the output member being coupled to the cradle for movement therewith.

12. The actuator of claim 1, wherein the output member has a pair of arms.

13. An apparatus comprising:
a driveline component having a first shaft, a second shaft and an axially moveable element that is coupled for rotation with the first shaft, the axially movable element being movable between a first position, in which the axially movable element is decoupled from the second shaft, and a second position in which the axially movable element is rotatably coupled to the second shaft; and
an actuator having a housing, a first drive portion, a second drive portion, a rotary-to-linear converter, and an output member, the housing defining a first housing part and a second housing part that is segregated from first housing part by a housing wall, the first drive portion having an electric motor and an intermediate output that is driven by the electric motor, the first drive portion being housed in the first housing part, the second drive portion having an intermediate input and a transmission, the second drive portion being housed in the second housing part, the intermediate input receiving rotary power from the intermediate output and transmitting rotary power to the transmission, wherein the intermediate input does not physically contact the intermediate output and wherein the housing wall is disposed between the intermediate output and the intermediate input, the rotary-to-linear converter being driven by the transmission, the output member being translated along an axis by the rotary-to-linear converter;
wherein the axially movable element is coupled to the output member for movement therewith along the axis.

14. The apparatus of claim 13, wherein the intermediate output and the intermediate input are disposed about a common rotational axis.

15. The apparatus of claim 14, wherein the intermediate output and the intermediate input are disposed coaxially.

16. The apparatus of claim 14, wherein the intermediate output and the intermediate input are spaced apart along the common rotational axis.

17. The apparatus of claim 13, wherein the intermediate output is rotatable about a first axis and the intermediate input is rotatable about a second axis that is not coincident with the first axis.

18. The apparatus of claim 17, wherein the second axis is parallel to the first axis.

19. The apparatus of claim 13, wherein the intermediate output comprises a plurality of first magnets and the intermediate input comprises a plurality of second magnets that cooperate with the first magnets to transmit rotary power between the intermediate output and the intermediate input.

20. The apparatus of claim 19, wherein each of the first magnets produces a first magnetic field, wherein each of the second magnets produces a second magnetic field and wherein the first magnetic fields magnetically cog with the second magnetic fields to transmit rotary power between the intermediate output and the intermediate input.

21. The apparatus of claim 19, wherein the first magnets cooperate with the second magnets to resist relative rotation between the intermediate output and the intermediate input.

22. Currently Amended) The apparatus of claim 13, wherein the rotary-to-linear converter comprises a jackscrew and a bobbin that is threaded to the jackscrew.

23. The apparatus of claim 23, wherein the rotary-to-linear actuator further comprises a spring and a cradle, the spring being disposed between the bobbin and the cradle, the output member being coupled to the cradle for movement therewith.

24. The apparatus of claim 13, wherein the output member has a pair of arms.
